(19) United States
(12) Patent Application Publication
(10) Pub. No.: US 2024/0246622 A1
(43) Pub. Date: Jul. 25, 2024

(54) Tracked Vehicle Having a Track Tensioner

(71) Applicant: Rheinmetall Landsysteme GmbH, Unterlüß (DE)

(72) Inventor: Detlev Eckhoff, Selent (DE)

(21) Appl. No.: 18/565,722

(22) PCT Filed: Jul. 8, 2022
(86) PCT No.: PCT/EP2022/069072

§ 371 Date: Nov. 30, 2023

(30) Foreign Application Priority Data
Aug. 9, 2021 (DE) 10 2021 120 647.2

(51) Int. Cl. B62D 55/30

(52) U.S. Cl. CPC B62D 55/305

(57) ABSTRACT

A tracked vehicle having a track tensioner and a method for adjusting a track tension of a continuous track of a tracked vehicle is disclosed. The track tensioner includes a ball head spindle engaged with an idler wheel support that is engaged with an idler wheel. The idler wheel is engaged with the continuous track. The ball head spindle linearly moves relative to a hull of the tracked vehicle to increase or decrease the tension of the continuous track. A locking device selectively locks the ball head spindle from moving. An energy is supplied to the ball head spindle and the locking device to move or lock the ball head spindle from moving. An operating unit, a control unit, and an energy supply unit control movement of the track tensioner allowing the track tension to be adjusted from the interior of the tracked vehicle.

### CROSS-REFERENCE TO RELATED APPLICATION(S)

This application is filed pursuant to 35 U.S.C. § 371 claiming priority benefit to PCT/EP2022/069072 filed Jul. 8, 2022, which claims priority benefit to German Patent Application No. 102021120647.2 filed Aug. 9, 2021, the contents of both applications are incorporated herein by reference in the entirety for all purposes.

### TECHNICAL FIELD

The present invention relates to a tracked vehicle comprising at least one track tensioner. Relevant track tensioners are needed by tracked vehicles for tensioning the continuous track with a particular tension to optimize the movement of the track. The invention relates, in particular, to an automated adjustment and a digital operation of the track tensioner.

### BACKGROUND

Track tensioners for tracked vehicles are safety-relevant components that are subjected to high stresses due to the traction and steering forces as well as the braking forces that have to be transferred during travel. In principle, track tensioners are needed to be able to adjust a defined track tension.

During the break-in processes and due to wear of the continuous track, the continuous track is being stretched which leads to a reduction of track tension. For this reason, a continuous track must be re-tensioned as part of maintenance work. In addition, the track tensioner enables the continuous track to be put on and taken off by completely relaxing the continuous track.

As is generally known, the track tension is checked by geometrically measuring the sag on the track's upper run and, if necessary, manually adjusted on the mechanically or hydraulically operated track tensioner. Operating the mechanical, or the hydraulic track tensioner, requires direct access to the respective track tensioner, because the tensioning process must be carried out through several successive operations using special tools.

WO 2014/139906 A1, for example, shows a pertinent track tensioner which operates a continuous track via an electric tensioner integrated in the running gear to create the tension of the continuous track.

Due to constantly increasing protection requirements for current tracked vehicles, access to the running gear and thus also to the track tensioner is only possible to a very limited extent. In some cases, this means that with conventional solutions, the side guards have to be dismantled or are designed to be folded away in a time-consuming manner. Foldable designs have the disadvantage that they lead in part to a reduction in protection and also each time take up valuable time of the vehicle crew.

With previously known track tensioners, adjustment and locking are generally effected by means of corresponding movement or fastening threads. In addition, there are hydraulically actuated track tensioners in which the tensioning force is applied, for example, by an external hydraulic hand pump and, after tensioning, mechanical locking takes place by means of corresponding movement or fastening threads.

In this way, only the tensioning forces have to be transferred via the adjustment system. In these designs, the significantly higher dynamic driving forces are transferred mechanically with the aid of a locking mechanism, in particular also for safety reasons.

To operate the previously known track tensioners, direct access to the track tensioner is often necessary, which can only be realized to a very limited extent, in particular, in new tracked vehicle developments, due to the constantly increasing protection requirements.

In general, the problem with known track tensioners is that before and after adjusting the track tension, the track tension must be measured in the difficult-to-access running gear area by means of an indirect measurement of the track sag. This is usually done by stretching a rope between two support rollers in the track's upper run. In practice, a special tool consisting of measuring rods is usually used for the measurement, which are connected to the track via magnetic feet and allow the track sag to be measured.

Furthermore, due to the ever-increasing side protection requirements, access to the track tensioner for operation has so far usually had to be realized by means of elaborate swiveling or folding devices. Accordingly, the track vehicle is preferably designed as a military, armored track vehicle.

According to the prior art, the special tool for measuring the track tension and operating the track tensioner must also be stowed securely in or on the vehicle.

In doing so, the special tool reduces the payload and the stowage volume of the vehicle.

Also, with known mechanical track tensioners, a very high torque is required to adjust the necessary track tension in the case of mechanically operated track tensioners, which can only be applied using a correspondingly large special tool and a high level of force.

With known hydraulically operated track tensioners, an external hydraulic pump must be connected and used for each adjustment process. A possible locking of the system for travel operation is often done via a shear connection.

In the past, hydraulic track tensioners have also been implemented without a mechanical locking device, but these have the safety-relevant disadvantage that the track tension is lost in the event of a hydraulic leak, which can also severely impair steering and braking capability.

DE 2 030 019 A discloses such a track tensioner for continuous tracks which acts directly on a idler wheel of the continuous track and thus establishes the tension of the continuous track. However, this track tensioner cannot be locked and must therefore be permanently acted upon with a hydraulic energy.

### SUMMARY

It is therefore the object of the present invention to reduce the aforementioned disadvantages of the prior art.

Thanks to the invention, measuring and adjusting as well as locking the track tension can be done automatically from the driver's seat without requiring access to the difficult-to-access and usually heavily soiled running gear.

Large and heavy special tools for measuring and tensioning the track tension are no longer needed and no longer have to be stowed in the already very limited available stowage space of the vehicle.

The time required for daily inspections by operators before and after use can be significantly reduced. In general, the maintenance effort and the maintenance time required for the running gear can also be reduced.

This object is achieved by the track vehicle according to claim 1 and the method for adjusting a tension of a continuous track according to claim 18.

A track tensioner according to the invention of the tracked vehicle has a ball head spindle which can act on an idler wheel support of the tracked vehicle and thus the position of the idler wheel relative to the vehicle hull can be changed depending on the position of the ball head spindle.

According to the present invention, the ball head spindle includes a locking device by means of which the movement of the ball head spindle can be locked whereby said movement can thus be prevented. For this purpose, the locking is designed to be releasable, so that the locking device can fix or release the ball head spindle.

By supplying energy, preferably a hydraulic pressurization of a ball head spindle, the track tensioner is extended and simultaneously a blocking spindle is caused to rotate.

The locking concept is based on the fixing or locking of the blocking spindle, in this case. This enables an exclusively mechanical transfer of the dynamic running gear forces, which are significantly higher compared to the hydraulically introduced clamping forces.

The fixing prevents the rotation of the blocking spindle by means of a clutch or brake, which ultimately leads to a mechanical blocking of the track tensioner.

The mechanical locking device may be constructed as a hydraulically released spring-loaded multi-disc brake or clutch, which may be of friction connection of positive connection design.

The aforementioned solution principle is the prerequisite for an automatic adjustment and a digital operation of the track tensioner.

The tracked vehicle includes a continuous track guided over an idler wheel. In addition, a track tensioner capable of acting on the idler wheel is proposed. For this purpose, the track tensioner includes an idler wheel support which is designed to be eccentric and pivotably couples the idler wheel to the tracked vehicle. Such coupling is carried out at a vehicle hull of the tracked vehicle.

Furthermore, the track tensioner includes a ball head spindle which can act on the idler wheel support, and thus the position of the idler wheel relative to the vehicle hull can be changed depending on the position of the ball head spindle.

According to the present invention, the ball head spindle includes a locking device by means of which the movement of the ball head spindle can be locked and thus movement can be prevented. For this purpose, the locking is designed to be releasable, so that the locking device can fix or release the ball head spindle.

For this purpose, an energy, preferably hydraulic energy, can be applied to the ball head spindle. Embodiments using electrical energy are also possible.

When the ball head spindle is supplied with energy, said ball head spindle can move according to the amount of energy and thus act on the idler wheel, which changes its position accordingly and is able to tension the continuous track. Once the desired tension is reached, the energy can be switched off so that the ball head spindle is no longer supplied with energy. The locking device can then lock the ball head spindle in its position so that the tension of the continuous track is maintained.

The ball head spindle is preferably designed to be movable in a longitudinal direction and is at least partially supported in the spindle housing. As a result, the ball head spindle can be further moved out of or moved into the spindle housing during the longitudinal movement.

In a particular embodiment, the longitudinal movement of the ball head spindle is caused by a rotatable blocking spindle. When energy is applied, the blocking spindle then causes a rotational movement about its own axis and causes the longitudinal movement of the ball head spindle. This is accomplished by means of a guide thread between the ball head spindle and the blocking spindle.

The ball head spindle is coupled to the idler wheel support by means of a ball head to be able act on said idler wheel support.

The spindle housing preferably includes at least one mount for fastening the spindle housing to the tracked vehicle, preferably to the vehicle hull. For this purpose, the mount may be designed as a boring or as pins. The mount may also be designed for producing a welded connection. To this end, the mount may have a weldable surface.

To enable the spindle housing to follow the movement of the ball head spindle a special design is further proposed in which the spindle housing is pivotally connected to the mount via a bearing.

The locking device according to the invention is preferably designed as a clutch. For this purpose, it is proposed that the locking device is designed as a dog clutch for establishing a positive connection. The dog clutch then follows the movement of the blocking spindle and is thus rotatable.

Furthermore a longitudinally movable clutch piston is proposed, which can positively engage with the dog clutch. Because the clutch piston is designed to be longitudinally movable only and the dog clutch rotatably, the clutch piston can prevent the movement of the dog clutch and thus of the blocking spindle when the positive connection is established. The blocking spindle and thus also the ball head spindle are then locked.

To release the clutch piston from the connection to the dog clutch, the clutch piston can be supplied with energy, preferably the same energy as is supplied to the ball head spindle. By applying energy to the clutch piston, said clutch piston moves away from the dog clutch and enables the rotational movement of the blocking spindle and thus of the ball head spindle.

To engage the clutch piston with the dog clutch, it is proposed that preferably at least one return spring acts on the clutch piston and thus moves said clutch piston by means of a spring force toward the dog clutch. The spring force then allows the clutch piston to form the desired positive connection with the dog clutch.

If the clutch piston is to disengage from the dog clutch, the energy supplied must overcome the energy of the spring force.

Such a tracked vehicle is preferably provided with two continuous tracks and thus also with two track tensioners. The continuous tracks are then arranged on the two sides of the tracked vehicle, respectively.

To supply the track tensioner with energy, preferably at least one connection is provided, for example as a hydraulic connection. An electric connection may be provided just as well.

In an embodiment, it is proposed to provide at least one operating unit in the track vehicle to be able to specify and thus adjust the track tension. This allows setpoints to be specified, which are implemented via an open-loop and closed-loop control unit, and a supply unit, which provides the required energy to the track tensioner, is controlled.

In the tracked vehicle comprising the track tensioner, it is not necessary to maintain the energy for tensioning the continuous track. Energy only needs to be supplied for the tensioning process itself, for example, via the supply unit. The supply of energy can subsequently be stopped again.

Hydraulic or electrical energy is supplied to the track tensioner, for example, via the at least one connection. The supplied energy acts on the clutch piston and simultaneously on the blocking spindle. As a result, when the energy is being supplied, the blocking spindle and thus the ball head spindle are supplied with sufficient energy first, so that when the dog clutch disengages, the position of the ball head spindle and thus the idler wheel is not changed.

Due to the energy supplied, the spring force is overcome and thus the clutch piston is moved away from the dog clutch. This breaks the positive connection and disengages the locking spindle. This operation disengages the locking device.

The energy supply can then be changed as required, for example, by the open-loop and closed-loop control unit. If the track tension is to be reduced, the energy supply can also be reduced. If the track tension is to be increased, the energy supply can also be increased.

With a higher energy supply, the ball head spindle is moved further out of the housing by the blocking spindle. With a lower energy supply, the ball head spindle is moved further into the housing by the blocking spindle. The movement of the ball head spindle acts on the idler wheel support and changes the position of the idler wheel. This adjusts the track tension.

After the change in track tension has been carried out, the energy supply can be terminated. To do this, the supplied energy is reduced. Due to the reduced energy, the spring force now exceeds the force acting on the clutch piston as a result of the supplied energy. As a result, the spring force moves the clutch piston back toward the dog clutch, thus restoring the positive connection between the dog clutch and the clutch piston.

The positive connection prevents a rotational movement of the dog clutch and thus also the rotational movement of the blocking spindle. Since the blocking spindle can no longer move in a rotational manner, the position of the ball head spindle is locked. The set track tension is maintained.

The required track tension can be adjusted at the operating unit, for example. For this purpose, an operating unit may enable the selection of the tension of one or more continuous tracks on the vehicle. Thus the operating unit generates setpoints for the track tension. These setpoints can then be supplied to the open-loop and closed-loop control unit which converts the setpoints into control variables.

These control variables can be used to control the supply unit, which provides the energy that is supplied to the track tensioner. For this purpose, the open-loop and closed-loop control unit can output the variables proportionally to the setpoints (P-control behavior). However, the open-loop and closed-loop control unit can suitably approach the setpoints using its integral action (I- or Pl-control action).

The open-loop and closed-loop control unit can also be designed in such a way that first an approach to the energy, which is necessary to exceed the spring force, takes place, then an approach to the required setpoint, and then a decreasing of the supplied energy to allow the dog clutch to become operative.

In a particular embodiment, the spindle housing includes a plurality of ports to split and to be able to separately control or regulate the amount of energy supplied to the clutch piston and the amount of energy supplied to the blocking spindle.

A tracked vehicle having a continuous track which is guided by an idler wheel is proposed. At the same time, a track tensioner is proposed which includes an idler wheel support which connects the idler wheel to a vehicle hull of the tracked vehicle in a rotatable and eccentric manner. Furthermore, the track tensioner according to the invention includes a ball head spindle which can act on the idler wheel support. Being acted on can change the position of the idler wheel. For this purpose, the ball head spindle includes a locking device for preventing the movement of said ball head spindle.

To adjust the tension of a continuous track for the tracked vehicle, it is proposed that setpoints for a tension are set for at least one of the continuous tracks via an operating unit. These setpoints are converted into corresponding control and/or controlled variables by the open-loop and closed-loop control unit. The supply unit applies a corresponding energy on the ball head spindle as well as the clutch piston. The energy causes the clutch piston to be released from the positive connection against the force of the return spring. The supply unit then extends the ball head spindle according to the setpoints and the ball head spindle changes the position of the idler wheel support. Afterwards, the supply unit reduces the energy to the clutch piston so that the force of the return spring brings the clutch piston into engagement with the dog clutch. Finally, the supply unit switches off the energy to switch the track tensioner force free.

After adjusting the track tension, the system can be locked automatically. After locking, the hydraulic actuation can be depressurized. During travel, the entire power transmission is exclusively mechanical in order to ensure safety even in the event of high dynamic driving forces.

The track tension can be preselected and automatically adjusted as an explicit force responsive to ground conditions and purpose. This results in a reduction in wear, as the track tension in previously known solutions can now cover all ground conditions and purposes with one adjustment. The improved service life of the continuous track is also due to the fact that the correct track tension can be checked more frequently by quickly and easily adjusting the tension from the operator's station and can be maintained.

The track tensioner is interface-compatible with a wide range of known track tensioners and can be used on existing vehicles (tracked vehicles). Also, the automated adjustment of the track tension provides the prerequisite for a height-adjustable track running gear, for which the track tension must be adjusted or readjusted based on the running gear height.

### BRIEF DESCRIPTION OF THE DRAWINGS

Further features will be apparent from the figures. In the figures:

FIG. 1: is a side view of a part of a tracked vehicle according to the invention comprising an idler wheel and a track tensioner;

FIG. 2: is a perspective representation of a ball head spindle, which is partially accommodated in a spindle housing;

FIG. 3: shows a cross-section of a ball head spindle, which is partially accommodated in a spindle housing;

FIG. 4: is a block diagram of the components for adjusting a track tension on a tracked vehicle.

### DETAILED DESCRIPTION

FIG. 1 shows a portion of a tracked vehicle according to the invention. Such a tracked vehicle preferably includes two continuous tracks 2 for moving the vehicle. The portion shows the part of the vehicle hull 1, on which an idler wheel 8 is mounted. Idler wheels 8 are required for guiding, directing and deflecting the continuous track 2 and are thus part of a tracked drive.

A track tensioner according to the invention is also shown. The track tensioner includes an idler wheel support 7 designed as an eccentric cam and a linear track tensioner for adjusting the track tension.

The linear track tensioner includes a ball head spindle 6 and a spindle housing 5, which transfers the applied force to a spindle housing 5 of the track tensioner and ultimately to the vehicle structure.

To enable the linear track tensioner to follow the eccentric movement of the idler wheel support, the ball head spindle 6 is at least partially accommodated in the spindle housing 5 and can be moved longitudinally therein. Likewise, the ball head spindle 6 is pivotably mounted to the idler wheel support 7 and the spindle housing 5 is also pivotably mounted to a mount 3.

The ball head spindle 6 can be hydraulically retracted and extended to change the track tension. Electric retraction and extension is also conceivable. The track tension is adjusted through the position assumed by the idler wheel 8.

A locking device 4 is associated with the track tensioner. The locking device 4 can impede the movement of the ball head spindle 6 and the position of the ball head spindle 6 as well as the position of the idler wheel support 7 and the idler wheel 8 can thus be locked.

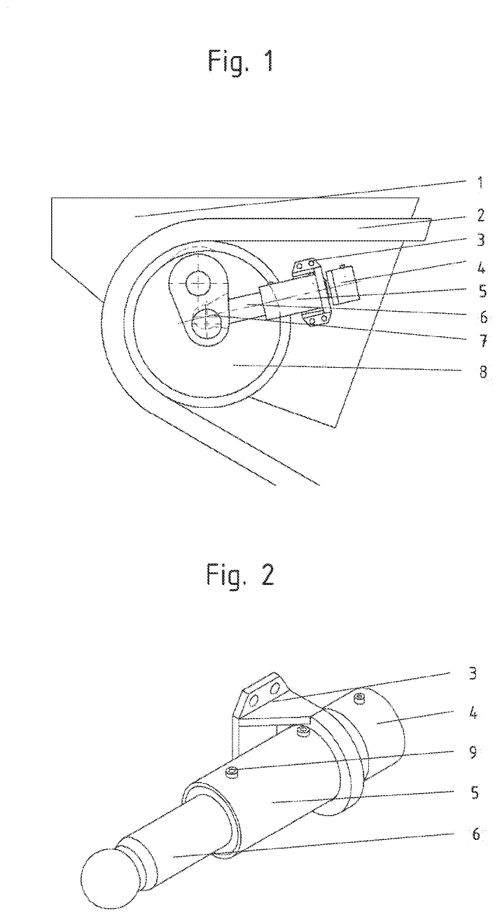

FIG. 2 shows a perspective illustration of the ball head spindle 6 as part of the locking device 4, the ball head spindle being partially accommodated in a spindle housing 5 and supported therein in a longitudinally movable manner. The spindle housing 5 can be mounted to the vehicle hull 1 by means of the mount 3. For this purpose, holes are provided in this embodiment, which can engage with respective pins or screw connection on the vehicle hull 1.

To cause a movement of the ball head spindle 6, the track tensioner can be supplied with energy via ports 9. The ports 9 are preferably designed as hydraulic ports. The locking device 4 and the ball head spindle 6 can be supplied with energy via the ports to move both components.

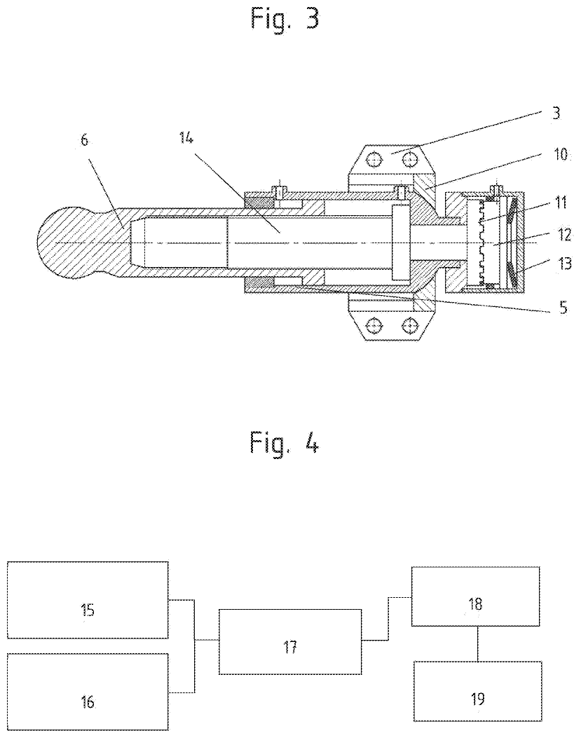

FIG. 3 shows a cross-section of the ball head spindle 6 and the spindle housing 5. The ball head spindle 6 has a hollow bore and is provided with a non-self-locking movement thread. For locking the track tensioner, a blocking spindle 14 is integrated, concentrically to the ball head spindle 6, and mounted in a rotatable manner. As soon as the ball head spindle 6, which is secured against rotation, is moved hydraulically, the blocking spindle 14 is set in rotation.

The locking is carried out by fixing the blocking spindle 14 by means of a dog clutch 11 and a clutch piston 12 loaded by at least one return spring 13. The dog clutch 11 is disengaged hydraulically by means of the clutch piston 12, which is designed as a piston, by compressing the return spring 13.

Alternatively, the locking device 4 can also be designed as a hydraulically released spring-loaded multi-disc brake or as a frictionally or positively engaged clutch of a different type.

When energy is supplied, said energy can first overcome the spring force of the return spring 13 and move the clutch piston 12 against the spring force and thereby disengage the clutch piston 12 from the dog clutch 11. After the dog clutch 11 is disengaged, said dog clutch is no longer held in its position and thus enables the movement of the blocking spindle 14 and thus the movement of the ball head spindle 6.

The supplied energy can also cause the blocking spindle 14 to rotate so that the ball head spindle 6 performs a longitudinal movement and transfers said movement to the idler wheel support.

Also shown in FIG. 3 is the bearing 10, in which the spindle housing 5 is pivotably or rotatably mounted for following the movement.

The automatic track tensioner system consists essentially of the following tracked vehicle components shown in FIG. 4 and the necessary hydraulic and/or electrical connecting lines.

In a tracked vehicle having two tracks, an exemplary tensioning process according to the invention is carried out for each track by means of the track tensioners as described below:
The driver initiates the tensioning process via an operating unit 19;
The driver sets the desired track tension on the operating unit 19 and the operating unit uses this to generate setpoints for the subsequent open-loop or closed-loop control;
The electric open-loop and closed-loop control unit 18 sends the commands resulting from the setpoints to the hydraulic supply and control unit 17;
The hydraulic system applies the hydraulic pressure to the piston side of the ball head spindle 6 and thus releases the positive connection between dog clutch 11 and clutch piston 12;
The hydraulic system disengages the positive connection between the dog clutch 11 and the clutch piston 12;
The ball head spindle 6 is extended or retracted by means of the pressure on the piston side;
Once the required track tension is reached, the dog clutch 11 is de-energized and mechanically locked by the return spring 13;
Once the positive connection is established, the track tensioner is completely depressurized by reducing or switching off the supplied energy.

The aforementioned steps result from the presence of an operating unit 19, an open-loop and closed-loop control unit 18, and the supply unit 17.

In absence of an operating unit 19, a setpoint can be specified for the open-loop and closed-loop control unit 18 via other means, for example via a mobile setting device.

In absence of an open-loop and closed-loop control unit 18, the operating unit 19 or the supply unit 17 can also take over the closed-loop or open-loop control.

Finally, the supply unit 17 may also be a supply unit already present in the vehicle.

The actual tension of the continuous track can then be measured via appropriate sensors or measurement devices and feed back to the open-loop and closed-loop control unit 18. For this purpose, appropriate sensors or measurement devices can be arranged on the continuous track itself or on the idler wheel 8 or on the idler wheel support 7. A signal transmission to the open-loop and closed-loop control unit 18 can be realized by means of electrical wires or as a wireless transmission.

The present invention is not limited to the aforementioned features. Rather, further embodiments are conceivable. For example, the locking device 4 may be designed as a brake. Also, the blocking spindle 14 can be electrically driven and thus the connections can be at least partially designed to be electrical connections. A combination of an electrical locking device and hydraulic spindle drive (or vice versa) is also conceivable.

### REFERENCE NUMBERS

1 Vehicle hull
2 Continuous track
3 Mount
4 Locking device
5 Spindle housing
6 Ball head spindle
7 Idler wheel support
8 Idler wheel
9 Connection (connections)
10 Bearing
11 Dog clutch
12 Clutch piston
13 Return spring
14 Blocking spindle
15 Track tensioner left
16 Track tensioner right
17 Supply unit
18 Open-loop and closed loop control unit
19 Operating unit

1. A tracked vehicle comprising:
a continuous track engaged with an idler wheel; and
a track tensioner comprising:
an idler wheel support engaged with the idler wheel and configured to connect the idler wheel with a vehicle hull of the tracked vehicle in a rotatable and eccentric manner; and
a ball head spindle configured to act on the idler wheel support such that, depending on a position of the ball head spindle, a position of the idler wheel relative to the vehicle hull can be changed, the ball head spindle further comprising a locking device configured to selectively lock or release movement of the ball head spindle.

2. The tracked vehicle according to claim 1, further comprising at least one of an amount of hydraulic or electric energy applied to the ball head spindle such that, depending on the amount of energy applied, the ball head spindle is retracted or extended.

3. The tracked vehicle according to claim 2, wherein the ball head spindle is supported in a spindle housing in a longitudinally movable manner relative to the spindle housing.

4. (canceled)

5. (canceled)

6. (canceled)

7. The tracked vehicle according to claim 1, wherein the track tensioner further comprising a blocking spindle engaged with the ball head spindle, the blocking spindle is configured to rotate about an axis to move the ball head spindle in a longitudinal direction relative to the vehicle hull.

8. The tracked vehicle according to claim 7, wherein the track tensioner further comprises a guide thread between the ball head spindle and the rotatable blocking spindle.

9. The tracked vehicle according to claim 7, wherein the locking device comprises a dog clutch configured to follow a rotational movement of the blocking spindle.

10. The tracked vehicle according to claim 9, wherein the locking device further comprises a longitudinally movable clutch piston configured to selectively positively engage with the dog clutch.

11. The tracked vehicle according to claim 10, wherein the locking device further comprises at least one return spring configured to apply a force to the clutch piston in a direction of the dog clutch.

12. The tracked vehicle according to claim 1, wherein the locking device is comprises a spring-loaded multi-disc brake.

13. The tracked vehicle according to claim 2, further comprising a supply unit configured to supply the at least one of the hydraulic or electric energy.

14. The tracked vehicle according to claim 13, further comprising an electric open-loop and closed-loop control unit in communication with the supply unit.

15. The tracked vehicle according to claim 14, further comprising at least one operating unit in communication with the control unit.

16. The tracked vehicle according to claim 1, wherein the continuous track comprises a first continuous track and a second continuous track, each of the first continuous track and the second continuous track including a respective track tensioner.

17. (canceled)

18. A method for adjusting a track tension of a continuous track for a tracked vehicle according to claim 1, the method comprising the following steps:
applying at least one of hydraulic or electric energy to the locking device;
releasing the locking device;
applying an amount of at least one of hydraulic or electric energy to the ball head spindle;
retracting or extending the ball head spindle relative to the vehicle hull, depending on the amount of energy applied to the ball head spindle; and
locking the locking device.

19. The method according to claim 18, further comprising measuring the track tension by sensors.

20. The method according to claim 19, further comprising turning the applied energy off when a predetermined track tension is reached.

21. The method according to claim 18, further comprising establishing setpoints for setting the track tension for the continuous track.

22. A track tensioner for use on a tracked vehicle having a vehicle hull and an idler wheel engaged with a continuous track, the track tensioner comprising:
an idler wheel support engaged with the idler wheel, the idler wheel support is configured to eccentrically and pivotally couple the idler wheel to the vehicle hull;
a spindle housing configured to be connected to the vehicle hull;
a ball head spindle engaged with the idler wheel support and the spindle housing, the ball head spindle is configured to move in a longitudinal direction relative to the spindle housing;
a blocking spindle engaged with the ball head spindle, wherein on movement of the ball head spindle in the longitudinal direction to extend or retract the ball head spindle relative to the spindle housing, the blocking spindle rotates about an axis;
an energy supply unit in communication with the ball head spindle, the energy supply unit is configured to selectively supply an energy to the ball head spindle to extend or retract the ball head spindle in the longitudinal direction relative to the spindle housing to adjust a tension of the continuous track; and
a locking device in communication with the energy supply unit, the locking device is configured to selectively engage the blocking spindle to prevent movement of the ball head spindle in the longitudinal direction.

23. The track tensioner of claim 22, further comprising:
an operating unit positioned in an interior of the tracked vehicle having a driver's seat, the operating unit is in communication with the energy supply unit and is configured to establish setpoints to adjust the tension of the continuous track.

24. A track tensioner for use on a tracked vehicle having a vehicle hull and an idler wheel engaged with a continuous track, the track tensioner comprising:
an idler wheel support engaged with the idler wheel, the idler wheel support is configured to eccentrically and pivotally couple the idler wheel to the vehicle hull;
a spindle housing configured to be connected to the vehicle hull;
a ball head spindle engaged with the idler wheel support and the spindle housing, the ball head spindle is configured to move in a longitudinal direction relative to the spindle housing;
a blocking spindle engaged with the ball head spindle, wherein on rotation of the blocking spindle about an axis the ball head spindle moves in the longitudinal direction to extend or retract the ball head spindle relative to the spindle housing;
an energy supply unit in communication with the blocking spindle, the energy supply unit is configured to selectively supply an energy to the blocking spindle to extend or retract the ball head spindle in the longitudinal direction relative to the spindle housing to adjust a tension of the continuous track; and
a locking device in communication with the energy supply unit, the locking device is configured to selectively engage the blocking spindle to prevent movement of the ball head spindle in the longitudinal direction.
